(19) United States
(12) Patent Application Publication
(10) Pub. No.: US 2009/0313431 A1
(43) Pub. Date: Dec. 17, 2009

(54) Disk Array Recording Apparatus and Recording Control Method Thereof

(76) Inventors: Hajime TAKASUGI, Yokohama (JP); Toshiji NAKATOMI, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/483,360

(22) Filed: Jun. 12, 2009

(30) Foreign Application Priority Data
Jun. 13, 2008 (JP) JP2008-154972

(51) Int. Cl. G06F 12/00

(52) U.S. Cl. 711/114; 711/E12.001

(57) ABSTRACT

The present invention provides a disk array recording apparatus that is composed of a plurality of hard disk drives (HDDs) and capable of unfailingly decreasing the startup time required between power application and recording operation initiation. When three out of four HDDs 11-14 (e.g., HDDs 11-13) start up, a startup control circuit 4 starts recording input data by using a RAID scheme and causes a substitutional recording medium 19 to substitutionally record the data to be recorded onto the last HDD 14, which has not yet started up. When the last HDD 14 starts up, the data recorded on the substitutional recording medium 19 is accessed to restore the data within a substitution period and record the restored data onto the last HDD 14.

### CLAIM OF PRIORITY

The present application claims priority from Japanese patent application serial No. JP2008-154972, filed on Jun. 13, 2008, the content of which is hereby incorporated by reference into this application.

### BACKGROUND OF THE INVENTION

(1) Field of the Invention

The present invention relates to a disk array recording apparatus that records, for instance, surveillance camera image data in a suitable manner. The present invention also relates to a recording control method thereof.

(2) Description of the Related Art

For image recording apparatuses that record, for instance, surveillance camera image data, digital image compression technology improvement and recording medium capacity enhancement are promoted to meet a demand for long-duration, high-quality image recording. Employed recording media are now shifting to hard disks, DVDs, and other disk media. Among others, the hard disks are most frequently used because of their large capacity and low cost per capacity. A plurality of hard disk drives (hereinafter referred to as HDDs) are combined and used as a disk array apparatus to achieve longer-duration recording. The disk array apparatus is operated as a virtual hard disk drive to establish a RAID (Redundant Arrays of Inexpensive Disks) system.

A predetermined startup time is required for each HDD to start rotating its disk and become ready to read or write data. The startup time varies from one HDD to another by several seconds to several tens of seconds. A RAID system or other disk array recording apparatus composed of a plurality of HDDs does not become ready to write data until all the HDDs complete their startup sequence subsequently to power ON. In other words, it is necessary to wait until a HDD whose startup time is the longest is started up. This is a reason why the overall system startup time is increased.

A method for decreasing the above startup time is disclosed, for instance, in JP-A-11-328823. This method measures the startup time of each of a plurality of HDDs, defines a HDD startup sequence in which the HDDs are arranged in order from the longest startup time to the shortest, and sequentially starts the HDDs in the defined startup sequence at the time of next startup.

### SUMMARY OF THE INVENTION

The method disclosed in JP-A-11-328823 is developed on the assumption that a plurality of HDDs are sequentially started, instead of being simultaneously started, in consideration of power supply efficiency at startup. When the HDDs are started in such a manner, this method makes it possible to reduce the time required for the HDDs to become operative. However, the overall operations of the HDDs cannot be initiated until a HDD whose startup time is the longest is started up. In that sense, this method is similar to conventional ones. Further, the startup time of a HDD is affected by its preceding operation and an operating environment. Therefore, the startup time does not always remain the same. It means that a startup time reduction effect will not be consistently produced.

Surveillance equipment for recording the image data of a surveillance camera performs an unattended recording operation 24 hours a day. Even when a recording operation is interrupted, for instance, by a power failure, it is necessary that such surveillance equipment promptly resume the recording operation upon power restoration to minimize the time during which the recording operation is interrupted. In other words, it is demanded that the recording operation be resumed with the startup time minimized and without regard to the operating environment and an operation performed at the time of interruption.

An object of the present invention is to provide a disk array recording apparatus that is composed of a plurality of hard disk drives (HDDs) and capable of unfailingly decreasing the startup time required between power application and recording operation initiation.

According to a first aspect of the present invention, there is provided a disk array recording apparatus for recording input data distributively onto N (N is two or more) units of hard disk drives, the disk array recording apparatus including: a RAID control circuit, which exercises control so as to record the input data distributively onto the N units of hard disk drives by using a RAID scheme; a substitutional recording medium, which substitutionally records the data to be recorded onto the hard disk drives; and a startup control circuit, which controls the RAID control circuit and the substitutional recording medium when the apparatus starts up. When N−1 units of N hard disk drives start up, the startup control circuit causes the RAID control circuit to start recording the input data and the substitutional recording medium to substitutionally record the data to be recorded onto the last hard disk drive, which has not yet started up. When the last hard disk drive starts up, the startup control circuit accesses the data recorded on the substitutional recording medium, restores the data within a substitution period, and records the restored data onto the last hard disk drive.

According to a second aspect of the present invention, there is provided the disk array recording apparatus as described in the first aspect, wherein the RAID scheme is a method of generating a parity signal from the input data and distributively recording the parity signal and the input data; and wherein the startup control circuit causes the substitutional recording medium to record recording address information about the last hard disk drive, restores the data within the substitution period by using the parity signal, and records the restored data onto the last hard disk drive in accordance with the recording address information.

According to a third aspect of the present invention, there is provided the disk array recording apparatus as described in the first aspect, wherein a semiconductor memory or a substitutional recording area on each hard disk drive is used as the substitutional recording medium.

According to a fourth aspect of the present invention, there is provided a recording control method for use in a disk array recording apparatus that records input data distributively onto N (N is two or more) units of hard disk drives, the recording control method including the steps of: when N−1 units of N hard disk drives start up subsequently to apparatus startup, starting to record the input data distributively onto the running hard disk drives by using a RAID scheme, and causing a substitutional recording medium to substitutionally record the data to be recorded onto the last hard disk drive, which has not yet started up; and, when the last hard disk drive starts up, restoring the data within a substitution period from the data recorded on the substitutional recording medium and recording the restored data onto the last hard disk drive.

The disk array recording apparatus according to the present invention starts a recording operation before all HDDs start up subsequently to power application. This makes it possible to minimize the time during which recording is interrupted, and enhance the reliability of surveillance equipment to which the disk array recording apparatus is applied.

### BRIEF DESCRIPTION OF THE DRAWINGS

These and other features, objects, and advantages of the present invention will become more apparent from the following description when taken in conjunction with the accompanying drawings wherein:

FIG. 1 is a diagram illustrating the configuration of a disk array recording apparatus according to an embodiment of the present invention;

FIG. 2 is a diagram illustrating a recording operation of the disk array recording apparatus; and

FIG. 3 is a flowchart illustrating a recording control operation of the disk array recording apparatus.

### DETAILED DESCRIPTION OF THE EMBODIMENT

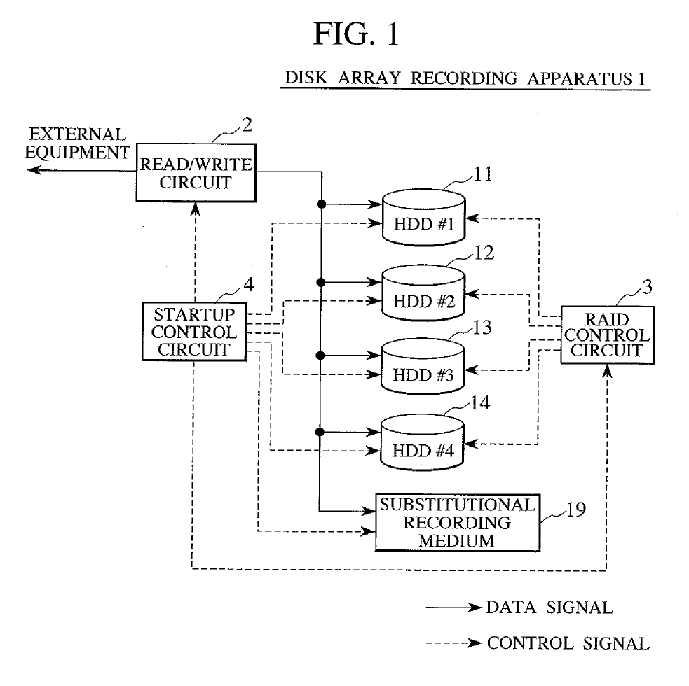

FIG. 1 is a diagram illustrating the configuration of a disk array recording apparatus according to an embodiment of the present invention.

The disk array recording apparatus 1 according to the present embodiment includes a substitutional recording medium 19 for use during apparatus startup in addition to a plurality of (four in an example shown in the figure) hard disk drives (HDDs #1 to #4) 11-14, and records data by making use of a RAID technology. A read/write circuit 2, which is included in the disk array recording apparatus 1, generates write data and a parity signal by processing an image signal that is input from a surveillance camera or other external equipment, and supplies the write data and parity signal to each HDD. The read/write circuit 2 also generates an image signal by processing read data obtained from each HDD. A RAID control circuit 3, which is also included in the disk array recording apparatus 1, records the write data and parity signal distributively onto running hard disk drives by using a RAID scheme. Further, a startup control circuit 4 is included in the disk array recording apparatus 1 according to the present embodiment. During a period before the startup of all HDDs is completed, the startup control circuit 4 uses the substitutional recording medium 19 to substitutionally record data onto a HDD that has not yet started up.

The substitutional recording medium 19 performs a substitutional recording operation for a HDD that starts up at the latest of the four HDDs (hereinafter referred to as the last HDD). The substitutional recording operation is performed during the time interval between the instant at which the startup of three HDDs is completed and the instant at which the startup of the last HDD is completed. It should also be noted that the substitutional recording medium 19 records the recording address information about the last HDD instead of write data. Therefore, a small-capacity medium can be used as the substitutional recording medium 19. For example, a flash memory or other similar semiconductor memory is suitable as the substitutional recording medium 19. An alternative would be to provide each of the four HDDs with a substitutional recording area and use the substitutional recording area of a running HDD as the substitutional recording medium 19. Upon completion of the substitutional recording operation, the read/write circuit 2 uses the parity signal to restore the data within a substitutional recording period (performs a rebuild process), and records the restored data at the associated address position of the last HDD. This ensures that the recording operation can be started before all the HDDs start up subsequently to power application.

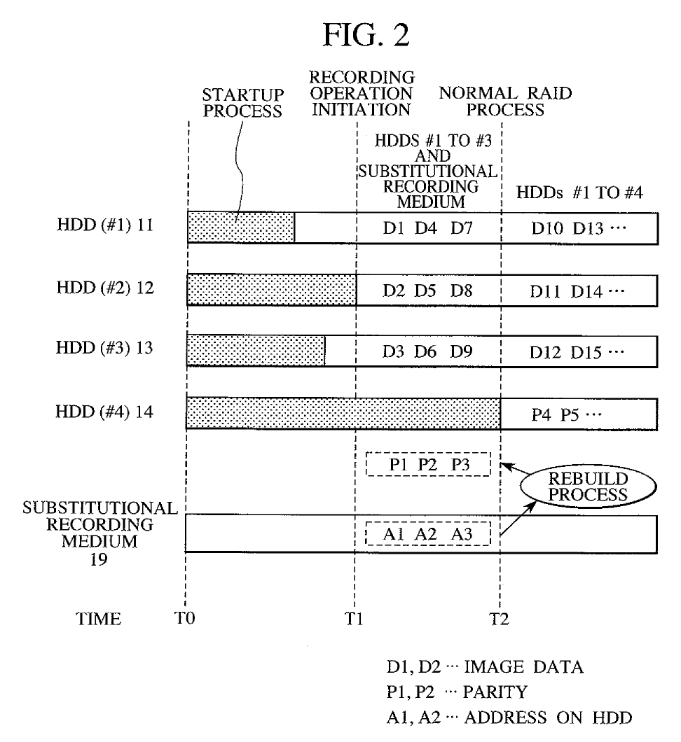

FIG. 2 is a diagram illustrating a recording operation of the disk array recording apparatus according to the present embodiment.

Under a RAID 5 scheme, the present embodiment sequentially records image data onto three HDDs and records error correction parity onto the remaining HDD. Under the RAID 5 scheme, the image data and parity recording destinations are distributively assigned to the HDDs at predetermined time intervals. The figure shows a case where image data D1, D2, D3, . . . are sequentially recorded onto HDDs #1 to #3 while parities P1, P2, P3, . . . are recorded onto HDD #4. Each parity is generated from three image data. For example, parity P1 is generated from image data D1, D2, and D3. This ensures that even when one of the four HDDs is damaged, the image data (or parity) recorded on the remaining three HDDs can be used to restore the damaged HDD's image data (or parity).

A process for startup, which is performed after power application to the apparatus, will now be described. When the apparatus turns ON at time T0, the startup control circuit 4 issues an instruction so that each HDD rotates a spindle motor to perform a startup process. Although the figure shows a case where the HDDs simultaneously start their startup process, the HDDs may be sequentially started in a predetermined startup sequence. Consequently, the HDDs complete their startup process in their own startup time. The completion of startup is verified in accordance with a command exchange with each HDD. The example shown in the figure indicates that HDDs #1, #3, #2, and #4 are started up in the order named. For example, conventional RAID apparatuses having four HDDs start a data recording operation at time T2 at which all the four HDDs are started up.

In the present embodiment, on the other hand, the startup control circuit 4 monitors the startup of each HDD and starts a data recording operation at time T1 at which three HDDs (HDDs #1, #3, and #2) are started up. At time T1, the startup control circuit 4 instructs the RAID control circuit 3 to record data under the RAID 5 scheme. The RAID control circuit 3 causes HDDs #1, #2, and #3 to record data D1, D2, D3, . . . , respectively. However, parities P1, P2, . . . cannot be recorded because HDD #4, which is the recording destination, is not started up. Therefore, the startup control circuit 4 causes the substitutional recording medium 19 to record HDD #4 address information A1, A2, . . . concerning the parities (P1, P2, . . . ) to be recorded on HDD #4. Under the RAID 5 scheme, missing parities can be restored from the associated image data. Therefore, the parities need not be substitutionally recorded. The parities can be restored as far as their recording destination addresses are known. In the manner described above, HDD #1 records image data D1, D4, and D7; HDD #2 records image data D2, D5, and D8; and HDD #3 records image data D3, D6, and D9. In addition, the substitutional recording medium 19 records addresses A1, A2, and A3, which relate to parities P1, P2, and P3, respectively.

When HDD #4, that is, the last HDD, subsequently starts up at time T2, all the HDDs can record data. After verifying that HDD #4 is started up, the startup control circuit 4 instructs the RAID control circuit 3 to perform a normal RAID process, thereby causing HDDs #1 to #3 to record image data D10, D11, D12, . . . and HDD #4 to record parities P4, P5, . . . .

In addition, the startup control circuit 4 starts a rebuild process after verifying that HDD #4 is started up. In the rebuild process, the read/write circuit 2 is used to restore data that was not recorded on a HDD. To restore such data, the startup control circuit 4 accesses the substitutional recording medium 19, reads addresses A1, A2, and A3, which were substitutionally recorded, and restores parities P1, P2, and P3, which should be recorded onto HDD #4. For example, parity P1 is generated by reading data D1, D2, and D3, which are recorded on HDDs #1, #2, and #3, and performing computations on the read data. Generated parities P1, P2, and P3 are then recorded at addresses A1, A2, and A3 of HDD #4 to restore the data within the substitutional recording period. The rebuild process can be performed in parallel with a normal RAID process that is performed after time T2 (while the HDDs are not used). Therefore, the rebuild process does not interrupt an operation that is performed to record input image signals.

In the above example, it is assumed that HDD #4, which records parities, is the last HDD, which starts up at the latest of the four HDDs. However, the rebuild process can also be performed even when HDD #1, #2, or #3, which records image data, is the last HDD. Under the RAID 5 scheme, missing image data can be restored from the associated two image data and parities. Therefore, the image data need not be substitutionally recorded onto the substitutional recording medium 19. Data restoration can be achieved as far as the associated recording destination address is recorded.

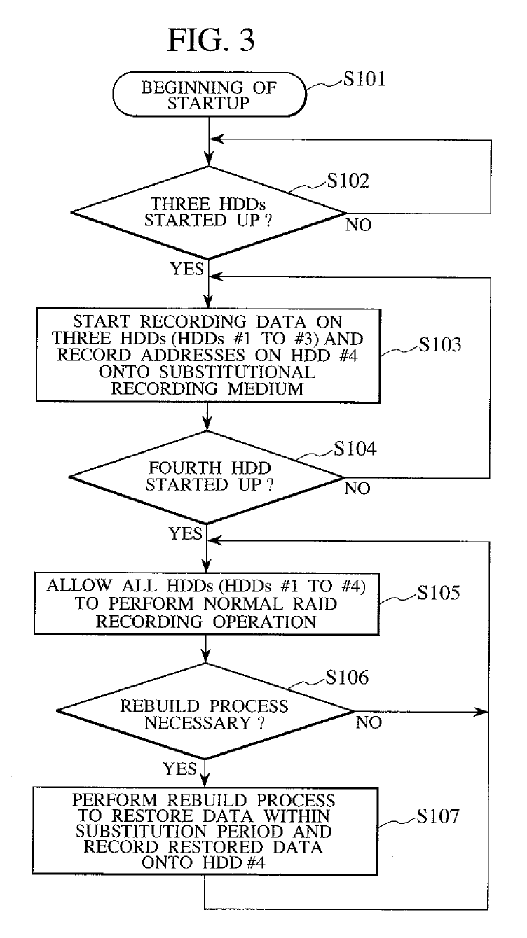

FIG. 3 is a flowchart illustrating a recording control operation according to the present embodiment. The flowchart is prepared on the assumption that the four HDDs (HDDs #1 to #4) are used to perform a RAID 5 process as is the case with the example shown in FIG. 2.

When the apparatus turns ON, a startup process for each HDD begins (step S101). The startup control circuit monitors the startup of each HDD and judges whether three HDDs are started up (step S102). When three HDDs (HDDs #1 to #3) start up, they are used to start recording image data and parities. As for the write data for HDD #4, which has not yet started up, the associated recording address on HDD #4 is recorded onto the substitutional recording medium 19 (step S103). While substitutional recording is being conducted, step S104 is performed to judge whether the fourth HDD (HDD #4) is started up.

When the fourth HDD (HDD #4) starts up, the RAID control circuit starts a normal RAID recording operation by using all HDDs (HDDs #1 to #4) (step S105). Step S106 is performed during the RAID recording operation to judge whether a rebuild process needs to be performed to restore data missing from a HDD. In the currently used example, a rebuild process for HDD #4 is necessary. Therefore, the missing data (parity) within a substitution period is restored by using the associated data (parity). The restored data is then recorded at the associated address position of HDD #4 (step S107). The rebuild process is fractionally performed while a RAID process is not performed. When the missing data is entirely restored, the rebuild process is terminated to repeat a normal RAID recording operation.

Performing the above steps eliminates the necessity of waiting until all HDDs start up and makes it possible to start a recording operation when three HDDs are started up. Therefore, the startup time required between power application and recording operation initiation can be unfailingly decreased. Further, the startup time of each HDD may vary with an operating history and operating environment. However, the present embodiment can start a recording operation with the startup time minimized because it always selects three HDDs in the order of startup completion.

The embodiment described above may be modified as described below.

Although the embodiment described above uses four HDDs, the number of HDDs is not limited to four. When N units of HDDs are used, a recording operation can be started when N−1 units of HDDs are started up. Further, a RAID scheme other than the RAID 5 scheme can also be used as far as it records data with parity information attached.

In the embodiment described above, the substitutional recording medium records recording address information about a HDD instead of write data (or parity information). However, if the substitutional recording medium has an extra capacity, it may record the write data (or parity information) itself. In such an instance, the processing time decreases because the rebuild process is performed to copy data.

The disk array recording apparatus according to the present embodiment is particularly suitable as surveillance equipment for recording images fed from a surveillance camera that operates constantly for 24 hours a day. Even when a power failure occurs during a recording operation and the disk array recording apparatus recovers from a power failure, the apparatus minimizes the time during which the recording operation is interrupted, thereby enhancing the reliability of the surveillance equipment.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A disk array recording apparatus for recording input data distributively onto N (N is two or more) units of hard disk drives, the disk array recording apparatus comprising:
a RAID control circuit, which exercises control so as to record the input data distributively onto the N units of hard disk drives by using a RAID scheme;
a substitutional recording medium, which substitutionally records the data to be recorded onto the hard disk drives; and
a startup control circuit, which controls the RAID control circuit and the substitutional recording medium when the apparatus starts up;
wherein, when N−1 units of N hard disk drives start up, the startup control circuit causes the RAID control circuit to start recording the input data and the substitutional recording medium to substitutionally record the data to be recorded onto the last hard disk drive, which has not yet started up; and
wherein, when the last hard disk drive starts up, the startup control circuit accesses the data recorded on the substitutional recording medium, restores the data within a substitution period, and records the restored data onto the last hard disk drive.

2. The disk array recording apparatus according to claim 1,
wherein the RAID scheme is a method of generating a parity signal from the input data and distributively recording the parity signal and the input data; and
wherein the startup control circuit causes the substitutional recording medium to record recording address information about the last hard disk drive, restores the data within the substitution period by using the parity signal, and records the restored data onto the last hard disk drive in accordance with the recording address information.

3. The disk array recording apparatus according to claim 1,
wherein a semiconductor memory or a substitutional recording area on each hard disk drive is used as the substitutional recording medium.

4. A recording control method for use in a disk array recording apparatus that records input data distributively onto N (N is two or more) units of hard disk drives, the recording control method comprising the steps of:
when N−1 units of N hard disk drives start up subsequently to apparatus startup, starting to record the input data distributively onto the running hard disk drives by using a RAID scheme, and causing a substitutional recording medium to substitutionally record the data to be recorded onto the last hard disk drive, which has not yet started up; and
when the last hard disk drive starts up, restoring the data within a substitution period from the data recorded on the substitutional recording medium and recording the restored data onto the last hard disk drive.

5. The recording control method for use in the disk array recording apparatus according to claim 4,
wherein the RAID scheme is a method of generating a parity signal from the input data and distributively recording the parity signal and the input data; and
wherein the substitutional recording medium is used to record recording address information about the last hard disk drive, restore the data within the substitution period by using the parity signal, and record the restored data onto the last hard disk drive in accordance with the recording address information.

6. The recording control method for use in the disk array recording apparatus according to claim 4,
wherein, when the last hard disk drive starts up, the recording operation is continuously performed by recording the input data distributively onto all hard disk drives while restoring the data within the substitution period from the data recorded on the substitutional recording medium and recording the restored data onto the last hard disk drive.
